(19) United States
(12) Patent Application Publication
(10) Pub. No.: US 2023/0240336 A1
(43) Pub. Date: Aug. 3, 2023

(54) EXTENDING FRUIT JUICE SHELF LIFE, CONSTITUENT MANIPULATION, AND QUALITY PRESERVATION PROCESS

(71) Applicant: SMARTFLOW TECHNOLOGIES, INC., Sanford, NC (US)

(72) Inventors: Jason BELL, Sanford, NC (US); Kelly JOHNSON, Sanford, NC (US); Todd BENSON, Sanford, NC (US); Thomas VOBORIL, Sanford, NC (US); Marc PUGH, Sanford, NC (US)

(21) Appl. No.: 18/161,253

(22) Filed: Jan. 30, 2023

Related U.S. Application Data
(60) Provisional application No. 63/304,100, filed on Jan. 28, 2022.

(51) Int. Cl. A23L 2/84; A23L 2/74; A23L 2/46

(52) U.S. Cl. CPC A23L 2/84; A23L 2/74; A23L 2/46

(57) ABSTRACT

A system for processing a raw juice feed to produce a final juice, and a method of using same, wherein the final juice has an extended shelf life while preserving many, if not all, of the desirable characteristics of freshly-squeezed juices including, but not limited to, the flavor, the mouthfeel, and aroma, without the need to include additives such as flavor and aroma packs. Advantageously, the final juice obtained using the method and system described herein can be stored at room temperature for at least 60 days and still retain the flavor of fresh juice, while still being sterile or having a reduced bioburden.

### CROSS REFERENCE TO RELATED APPLICATIONS

This application claims priority to U.S. Provisional Patent Application No. 63/304,100 filed on Jan. 28, 2022 in the name of Jason Bell et al., and entitled “Extending Fruit Juice Shelf Life, Constituent Manipulation, and Quality Preservation Process,” which is hereby incorporated by reference herein in its entirety.

### FIELD

The present invention relates generally to food processing and more particularly to systems and processes for producing various types of food juices which can be stored without refrigeration and without spoilage for at least 60 days. In addition, the systems and processes described herein can be used to produce designer food juices to specification.

### BACKGROUND

In processing various types of fruits and vegetables, it is often desirable to produce juices which retain the characteristics of fresh juice in order to market a product which is preferred by consumers. As a result, processors strive to produce juices which retain as many of the desirable characteristics of fresh juice as possible including, but not limited to, flavor, aroma, nutrition, appearance, and mouth feel. Presently, a tradeoff exists between fresh squeezed juices, having a substantially shorter shelf-life but many of the desirable characteristics, and processed juices having decreased quality but a longer shelf-life.

Disadvantageously, processes which produce juices suitable for storage involve steps which detract from these desirable characteristics. Most juices contain aroma and flavor components which are of low molecular weight and are easily volatilized at temperatures above 40° C. Producing a juice which can be stored generally requires pasteurization to destroy spoilage microorganisms which can cause complete loss of the product or result in undesirable off-flavors and odors. Pasteurization typically employs heating to at least about 62° C. for about 30 minutes, although higher temperatures for shorter periods may be employed (flash pasteurization). Consequently, these volatile flavor and aroma components are lost, detracting from the flavor and aroma of the final juice product.

The method and system described herein extend the shelf life of a fresh juice while preserving many, if not all, of the desirable characteristics of fresh squeezed juices including, but not limited to, the flavor, the mouthfeel, and aroma, without the need to include additives such as flavor and aroma packs. Advantageously, the juice obtained using the method and system described herein can be stored at room temperature for at least 60 days and still retain the flavor of fresh juice, while still being sterile or having a reduced bioburden.

### SUMMARY

In one aspect, a system for processing a raw juice feed to a final juice selected from the group consisting of a final juice comprising solids and a substantially solid-free final juice is described, said system comprising:
(a) a large pulp separation device to separate the raw juice feed into a first fraction comprising large pulp and a second fraction, wherein wash water is introduced during separation to strip some or all of the first fraction of sugars and other desirable species, and wherein the second fraction comprises at least one of juice, fine pulp, wash water, sugars, and other desirables;
(b) at least one liquid-solid separation device to separate the second fraction into a permeate comprising the juice, wash water, sugars and other desirables and a retentate comprising the fine pulp, suspended solids, and non-suspended solids;
(c) optionally, a hot pasteurization device, wherein at least a portion of the retentate, the first fraction, or both, are introduced and subjected to a temperature and a time necessary to kill microorganisms and to denature any undesirable enzymes to produce a sterile solid;
(d) a reverse osmosis (RO) device, wherein the permeate is introduced to standardize Brix and yield a RO permeate fraction comprising process water and a RO retentate fraction comprising standardized, substantially solid-free juice;
(e) at least one microorganism reduction device to sterilize the RO retentate fraction to produce a liquid that is sterile or otherwise has a substantially reduced bioburden, wherein the sterile liquid is the substantially solid-free final juice; and
(f) optionally, a recombiner for combining the sterile solid and the sterile liquid of (e) to produce a final juice comprising solids, wherein only the RO retentate fraction is introduced to the at least one microorganism reduction device to sterilize or reduce the bioburden of same to produce the sterilized RO retentate fraction for the final juice.

In another aspect, a method of processing a raw juice feed to produce a final juice selected from the group consisting of a final juice comprising solids and a substantially solid-free final juice is described, said method comprising:
(a) separating the raw juice feed into a first fraction comprising large pulp and a second fraction, wherein wash water is introduced during the separation to strip some or all of the first fraction of sugars and other desirable species, and wherein the second fraction comprises at least one of juice, fine pulp, wash water, sugars, and other desirables;
(b) separating the second fraction into a permeate comprising the juice, wash water, sugars and other desirables and a retentate comprising the fine pulp, suspended solids, and non-suspended solids;
(c) optionally heating at least a portion of the retentate, the first fraction, or both, at a temperature and a time necessary to kill microorganisms and to denature any undesirable enzymes to produce a sterile solid;
(d) introducing the permeate to a reverse osmosis device to standardize Brix and yield a RO permeate fraction comprising process water and a RO retentate fraction comprising standardized, substantially solid-free juice;
(e) reducing the microorganism count of the RO retentate fraction to produce a liquid that is sterile or otherwise has a substantially reduced bioburden, wherein the sterile liquid is the substantially solid-free final juice; and
(f) optionally, recombining the sterile solid and the sterile liquid of (e) to produce a final juice comprising solids,
   wherein only the RO retentate fraction is introduced to the at least one microorganism reduction device to sterilize or reduce the bioburden of same to produce the sterilized RO retentate fraction for the final juice.

Other aspects, features and embodiments of the invention will be more fully apparent from the ensuing disclosure and appended claims.

### BRIEF DESCRIPTION OF THE FIGURES

FIG. 1A. An embodiment of the system described herein that can be used to process a raw juice feed into a final juice.

FIG. 1B. A breakout of the diafiltration system in FIG. 1A.

FIG. 2A. Another embodiment of the system described herein that can be used to process a raw juice feed into a final juice.

FIG. 2B. Another embodiment of the system described herein that can be used to process a raw juice feed into a final juice, comprising further fractionation of the stage 2 retentate.

FIG. 2C. Another embodiment of the system described herein that can be used to process a raw juice feed into a final juice, comprising further fractionation of the stage 2 permeate.

FIG. 2D. Another embodiment of the system described herein using a single liquid-solid separation device that can be used to process a raw juice feed into a final juice.

FIG. 3. A generalized embodiment of a cross-flow filtration cassette device.

FIG. 4. Cross-flow filtration cassettes can be mounted between holder plates, which may be provided with suitable ports, for introduction of liquid source material to be separated in the cassettes, and for discharge or withdrawal of permeate and retentate.

### DETAILED DESCRIPTION, AND PREFERRED EMBODIMENTS THEREOF

Although the claimed subject matter will be described in terms of certain embodiments, other embodiments, including embodiments that do not provide all of the benefits and features set forth herein, are within the scope of this disclosure as well. Various structural and parameter changes may be made without departing from the scope of this disclosure.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents, and other references mentioned herein are incorporated by reference in their entirety. The materials, methods, and examples disclosed herein are illustrative only and not intended to be limiting.

“About” and “approximately” are used to provide flexibility to a numerical range endpoint by providing that a given value may be “slightly above” or “slightly below” the endpoint without affecting the desired result, for example, +/−5%.

The phrase “in one embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As defined herein, “desirables” include, but are not limited to, bioactive species, flavor- and aroma-contributing components, and nutrients.

As defined herein, “sterile filtration” is synonymously referred to as “0.2 micron absolute” via dead-end filtration or bioburden reduction filtration. Sterile filtration is the removal of viable microorganisms from a solution. In some embodiments, the commercial sterile filters rated by the ASTM F 838.05, which demonstrate removal of a standard test organism Brevundimonas diminuta at minimum concentrations of 10⁷ cfu/cm², or the equivalent thereof, have been used to attain the desired sterility. “Bioburden reduction” is defined herein as a reduction of microorganisms in a solution, but not to the level achieved using sterile filtration. For the purposes of the instant application, the terms “sterile” and “reduced bioburden” are not intended to be used interchangeably. A common process in the arts is to subject a solution to bioburden reduction before sterile filtration so as to extend the life of a more expensive sterile filter. Choosing whether to reduce bioburden, sterilize filter, or both (reduce bioburden then sterile filter), is up to the manufacturer and depends on how they intend to present their product, as readily understood by the person skilled in the art.

As defined herein, “flavor and aroma pack” components for oranges include, but are not limited to, at least one of peel oil, essence oil, and essence aroma which can be isolated from oranges or synthetically produced. Common components of peel oil, essence oil, and essence aroma include at least one of ethanol, methanol, 1-propanol, linalool, acetaldehyde, acetal, trans-2-hexanal, hexanal, octanal, decanal, neral, geranial, nonanal, citranellal, dodecanol, alpha-sinensal, beta-sinensal, ethyl acetate, ethyl butyrate, d-limonene, myrcene, valencene, alpha-pinene, and sabinene.

Fruit and vegetable juices comprise water, sugar solids, and non-sugar-solids. The sugar solids include at least one of sucrose, glucose, and fructose. The non-sugar solids, including acids and beneficial compounds, constitute the remaining of the juice solids. The beneficial compounds include but are not limited to vitamins, minerals, flavonoids, antioxidants, pulp, acids, carotenoids (color), pectin, free amino acids, lipids, enzymes, and other non-volatile compounds. Another way to characterize fruit and vegetable juices, e.g., orange juices, is that they comprise a serum fraction, a cloud fraction, and a pulp fraction, wherein the cloud fraction is suspended in the serum fraction. The “cloud fraction,” or “cloud,” gives rise to the opaque appearance of many juices and is the result of soluble and insoluble compounds released during juice extraction. In the case of orange juice, the solid particles are kept in suspension by the presence of soluble pectin in the juice. Cloud is an important quality attribute of most citrus juices and contributes to the characteristic flavor, color, and mouthfeel. The “serum fraction,” or “serum,” is the larger fraction of the juice and is clear and aqueous and substantially free of both suspended and non-suspended solids, or substantially solid-free. The “pulp fraction” can comprise different pulp sizes including (i) a “large pulp” or “floating pulp” fraction, which comprises larger solid particles such as pieces of ruptured cell sac and segment wall which float to the top after juice is stirred; and (ii) a “fine pulp” or “sinking pulp” fraction, which comprises small solid particles (<0.5 mm) which are suspended in the juice and settle from the juice with time or spin down in a centrifuge. Suspended pulp, bottom pulp and centrifuged pulp are sometimes used as synonyms for sinking pulp.

As defined herein, “Brix” or “° Brix” is a refractive index scale for measuring the quantity of soluble solids (including fructose, glucose, sucrose, acids, and other soluble solids) in a solution at a given temperature. For example, in extracted orange juice, the concentration of sugar typically varies from 9° Brix for early season varieties to 12° Brix for fruit harvested late in the season (for example in Florida). Using the systems and processes described herein, a raw juice feed can be processed to produce a final juice having a specific Brix rating, as understood by the person skilled in the art.

As defined herein, “substantially solid-free” corresponds to a solution comprising less than about 1 v/v % solids, or less than about 0.5 v/v % solids, or less than about 0.2 v/v % solids, or less than about 0.1 v/v % solids, based on the total volume of the solution. It should be understood that the solids include suspended as well as non-suspended solids as well as sugar solids and non-sugar solids.

“Substantially devoid” is defined herein to mean that less than 1 wt % of the indicated substance is in the solution. In some embodiments, “substantially devoid” means that less than 0.5 wt % of the indicated substance is in the solution. In some embodiments, “substantially devoid” means that less than 0.1 wt % of the indicated substance is in the solution. In some embodiments, “substantially devoid” means that less than 0.001 wt % of the indicated substance is in the solution.

Described herein is a system, and method of using same, wherein a raw juice feed is processed to produce a final juice that retains at least one of the desirable characteristics of freshly squeezed juice (e.g., flavor, aroma, nutrition, appearance, and/or mouthfeel), without the need to include additives such as flavor and aroma packs, all while extending the shelf-life of the juice. Advantageously, the final juice obtained using the system and method described herein can be stored at room temperature for at least 60 days and still retain the flavor of fresh juice, i.e., the raw feed juice, while still being sterile or having a reduced bioburden.

In some embodiments, the raw feed juice is derived from citrus fruit, including, but not limited to, oranges, grapefruit, limes, tangerines, lemons, and tangelos. In other embodiments, the raw feed juice is derived from apricot, cranberry, blueberry, grape, peach, pear, papaya, banana, pineapple, apple, kiwi, raspberry, strawberry, aloe, guava, mango, tomato, watermelon, or a mixture thereof. The raw feed juice can also be derived from vegetables, e.g., beets. In some embodiments, the raw feed juice is derived from oranges including, but not limited to, Pineapple oranges, Hamlin oranges, Parson Brown oranges, Valencia oranges, tangerines, mandarin oranges, blood oranges, naval oranges, and any combination thereof. The juices from these oranges can be used alone or blended to produce optimum flavor characteristics. Juice extraction can be carried out by any method known in the art of obtaining juice from fruits, as readily understood by the skilled artisan, such as by automatic juicing machines, by hand, or by an FMC extractor.

In some embodiments, the raw feed juice contains about 5% to about 15% solids by volume. Solids, as used here, include, but are not limited to, pulp solids, fruit solids, suspended solids, and other materials and particulate matter understood by one with skill in the art to be solids. The solids may be, for example, components of a freshly squeezed juice, particulate matter that falls out of the solution of a juice, or the solids may be added to the feed juice. The solids may have an approximate size of, for example, from between about 0.001 to about 1000 microns and above.

Broadly, the processing of a raw juice feed includes, but is not limited to, (a) using a large pulp separation device to separate large pulp from the juice and fine pulp as well as wash the large pulp using water, (b) separation of the fine pulp from the juice using at least one liquid-solid separation device (e.g., dead-end filtration, centrifugation, tangential cross-flow filtration, reverse osmosis), optionally with diafiltration, to yield a permeate and a retentate, (c) moving at least a portion, or all, of the solids, which includes the cumulative retentate from the at least one liquid-solid separation device and the large pulp from the separation device, to a heating means (e.g., a heat pasteurizer) to kill microorganisms and to denature any undesirable enzymes known to catalyze deterioration or decoloring of the juice (e.g., pectinesterase in orange juice) to produce a sterile solid fraction; (d) moving the cumulative permeate from the at least one liquid-solid separation device to at least one reverse osmosis (RO) device to standardize Brix and to obtain a process RO water fraction as a RO permeate and a substantially solids-free juice as a RO retentate; (e) moving the RO retentate to a microorganism reduction means to yield a “sterile liquid” which is a substantially solids-free juice that is sterile or otherwise has a substantially reduced bioburden; and (f) optionally recombining/reblending the sterile solid fraction and the sterile liquid to produce a final juice that can be packaged.

During separation using the large pulp separation device in (a), the sugars and other desirables are stripped from the large pulp using a water wash, e.g., the RO permeate produced by the system's RO device. Without being bound by theory, it is believed that the osmotic pressure caused by the interaction of the sugar rich juice sacs and the essentially sugarless RO permeate bursts the juice sacs in the large pulp and effectively releases some or all ofthe sugars and other desirables into the juice and fine pulp fraction, which are directed to the first (or only) liquid-solid separation device.

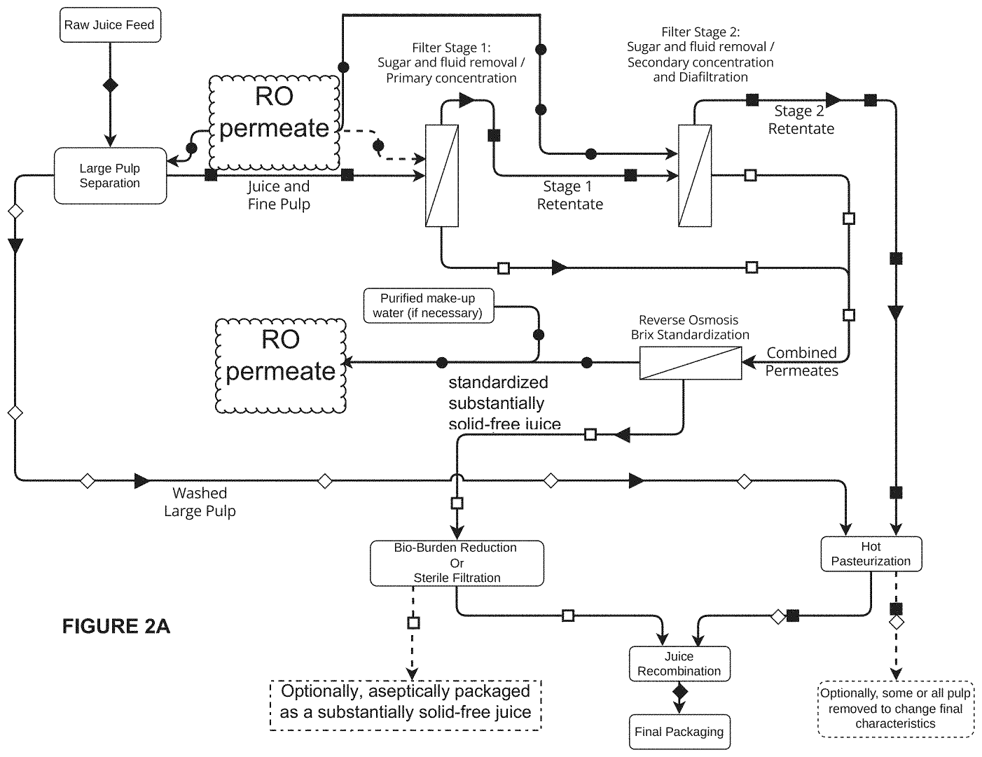

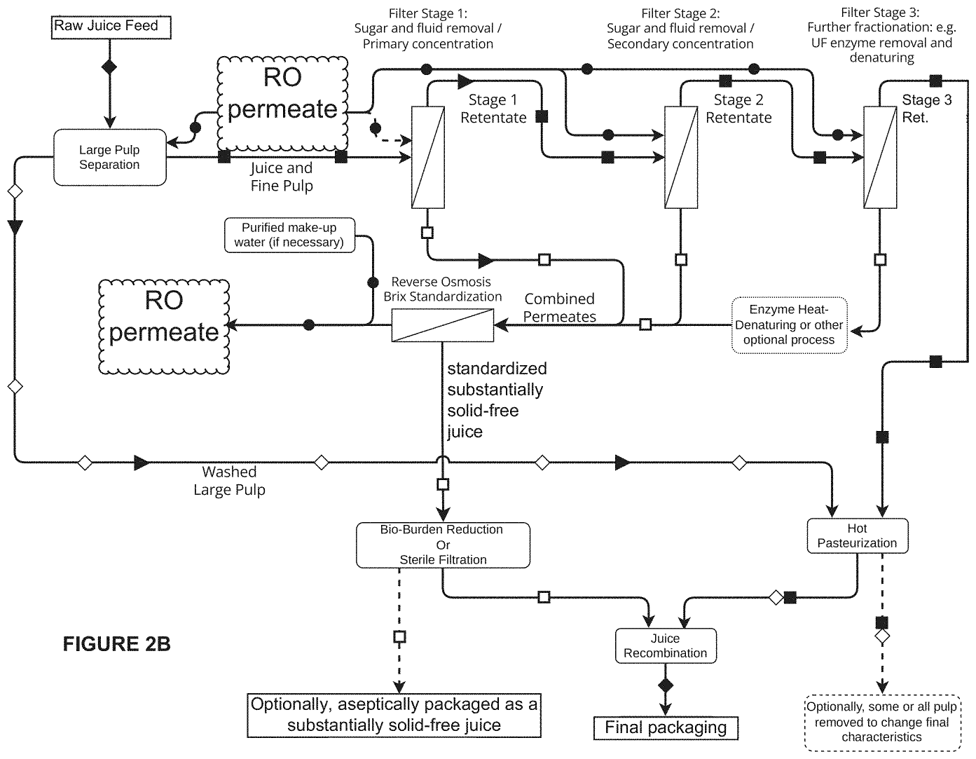

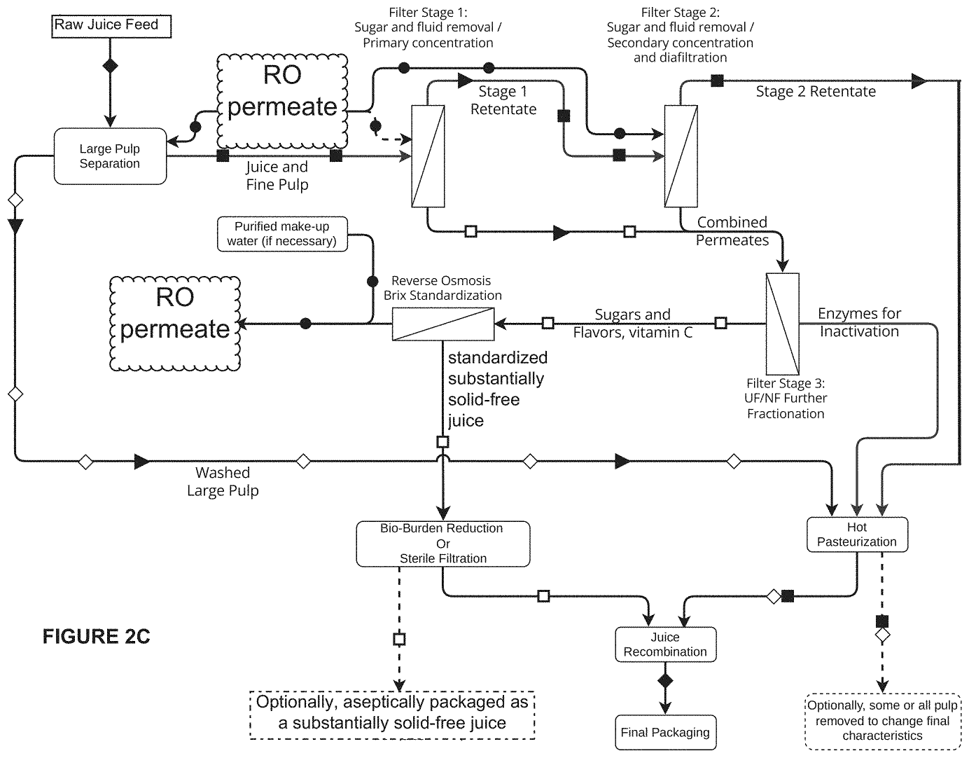

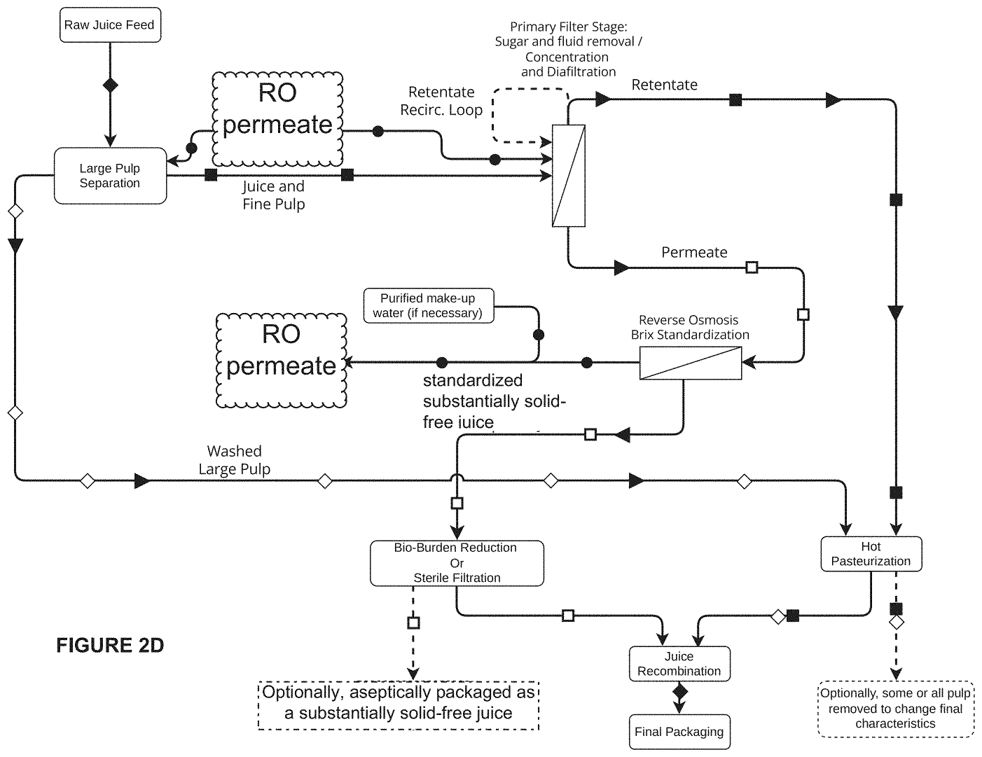

In some embodiments, the at least one liquid-solid separation device of (b) comprises a tangential cross-flow filtration device, e.g., as described herein. In some embodiments, the liquid-solid separation device consists of one cross-flow filtration device which includes diafiltration (see, e.g., FIG. 2D) and is processed continuously. In some embodiments, the liquid-solid separation device comprise at least two cross-flow filtration devices, for example, a first cross-flow filtration device to produce a first permeate and a first retentate, optionally including diafiltration, followed by cross-flow filtration and diafiltration of the first retentate in a second cross-flow filtration device to produce a second permeate and a second retentate. The first and second permeates can be combined to produce a cumulative permeate and the first and second retentates can be combined to produce a cumulative retentate. In some embodiments, every cross-flow filtration device defines a “stage,” wherein the cross-flow filtration device can comprise (i) a recirculation loop wherein at least a portion of the retentate from the cross-flow filtration device is reintroduced to the same cross-flow filtration device for further processing (not shown), and/or (ii) the cross-flow filtration device can be communicatively connected to a source of the RO permeate for optional diafiltration (shown in most of the figures). Recirculation loops and diafiltration are well known in the art. During diafiltration, the fine pulp vesicles are washed with water, e.g., the RO permeate produced by the system's RO device, such that they are stripped or broken open from shear to release some or all desirables in and/or on the fine pulp vesicles and are included in the first permeate. Following passage through the at least one liquid-solid separation device, substantially all of the desirables are in the permeate and the remaining solids in the retentate have been substantially stripped of desirables (e.g., the fine pulp has been washed and diafiltered yielding a heterogeneous mixture of largely diafiltration water, sugars, and other desirables in the permeate and insoluble solids comprising pulp vesicles and mouthfeel contributing constituents such as pectin in the retentate). It should be understood by the person skilled in the art that the liquid-solid separation device can include one, two, three, four, or more cross-flow filtration devices, arranged in series, or some combination of two, three, four, or more separation devices selected from the group consisting of dead-end filtration, centrifugation, tangential cross-flow filtration, and reverse osmosis.

In some embodiments of (e), the RO retentate is moved to a microorganism reduction means to produce a bioburden reduced or sterile liquid. The microorganism reduction means includes a bioburden reduction device, a sterile filtration device, or a combination of a bioburden reduction device and a sterile filtration device, in that order. In some embodiments, the microorganism reduction means (i.e., bioburden reduction device and/or sterile filtration device) never achieves a temperature greater than 30° C., maintaining the preservation of volatile flavor compounds and preventing other detrimental effects of heating on flavor. In some embodiments, the microorganism reduction means (i.e., bioburden reduction device and/or sterile filtration device) never achieves a temperature above 25° C. In some embodiments, the microorganism reduction means (i.e., bioburden reduction device and/or sterile filtration device) never achieves a temperature above 20° C. In some embodiments, the microorganism reduction means (i.e., bioburden reduction device and/or sterile filtration device) never achieves a temperature above 15° C. In some embodiments, only the standardized, RO retentate undergoes sterile or bioburden reduction filtration for the final juice.

In some embodiments of (f), the sterile solid fraction and the sterile liquid can be reblended/recombined to produce a final juice that can be packaged. In some embodiments of step (f), strategic recombination ensures that the level of desired components is targeted to the final juice designer's preference, e.g., not all of the sterile solid fraction is recombined with the sterile liquid. In some embodiments of step (f), the sterile liquid is the final juice that can be packaged. In some embodiments, the packaging is aseptic so as to eliminate the possibility of reintroducing microorganisms to the final juice.

In some embodiments, additional separation and concentration steps are added to further isolate individual components (e.g., to engineer the juice, specific enzymes, naturally-occurring dyes). For example, it should be appreciated by the person skilled in the art that not all enzymes present in juices are undesirable. Advantageously, the system/method can be adapted so the desirable enzymes, which are present in the remaining solids, are removed prior to heating/pasteurization. Additional filtration devices can be added, as understood by the person skilled in the art and described further herein with reference to FIGS. 2B and 2C, to isolate the fraction comprising the desired enzyme, and once isolated, the desired enzyme fraction can be added to the cumulative permeate prior to introduction of the permeate to the reverse osmosis device.

In one embodiment, a raw juice feed comprises a substantially homogeneous mixture of solids/pulp and liquids and the final juice has approximately the same solid to liquid ratio as the raw juice feed. In another embodiment, the raw juice feed comprises a substantially homogeneous mixture of solids/pulp and liquids and the final juice has a higher solid to liquid ratio relative to the raw juice feed. In still another embodiment, a raw juice feed comprises a substantially homogeneous mixture of solids/pulp and liquids and the final juice has a lower solid to liquid ratio relative to the raw juice feed. In some embodiments, the final juice is substantially solid-free, meaning that it comprises the sterile liquid but not the sterile solid fraction.

In some embodiments, the method is performed in a light-free environment to prevent degradation of the individual juice components during processing, as well as the final juice. In some embodiments, a nitrogen purge can be incorporated during the process, depending on the juice. For example, the raw juice feed or any added liquids can be sparged with nitrogen gas (or some other inert gas) to degas oxygen from said raw juice feed prior to introduction to the separation device. In addition, or alternatively, the empty processing system is primed with N₂ or some other inert gas to displace O₂ prior to raw juice feed processing so N₂ or other inert gas is present and maintained in the headspace.

In some embodiments, water is recovered and reutilized in the process, e.g., during reverse osmosis (RO) Brix standardization, and the RO permeate water can be used as a water feed during at least one process selected from the washing of the large pulp at the separation device, filtration and diafiltration at the first filtration unit, filtration and diafiltration at the second filtration unit (when present), and/or filtration and diafiltration at the third filtration unit (when present). In some embodiments, other than water needed at the time of process/system startup, the process/system is closed to the introduction of water not recovered during the process, meaning no additional water is added to the process/system during production of a raw juice feed to a final juice and as such, other than system/method startup, the only source of water in the system/method is that found in the original fruit or vegetables (or raw juice feed). At system startup, some water is needed to wash the large pulp in the large pulp separation device and the at least one liquid-solid separation device with diafiltration. Once the RO device is activated, RO permeate can thereafter be the only source of wash/rinse water in the system/process. That said, in some embodiments, in addition to the water needed at the time of process/system startup, some amount of additional water is added to the process/system during production of a raw juice feed to a final juice, as understood by the person skilled in the art.

Accordingly, in a first aspect, a system for processing a raw juice feed to a final juice selected from the group consisting of a final juice comprising solids and a substantially solid-free final juice is described, said system comprising:
(a) a large pulp separation device to separate the raw juice feed into a first fraction comprising large pulp and a second fraction, wherein wash water is introduced during separation to strip some or all of the first fraction of sugars and other desirable species, and wherein the second fraction comprises at least one of juice, fine pulp, wash water, sugars, and other desirables;
(b) at least one liquid-solid separation device to separate the second fraction into a permeate comprising the juice, wash water, sugars and other desirables and a retentate comprising the fine pulp, suspended solids, and non-suspended solids;
(c) optionally, a hot pasteurization device, wherein at least a portion of the retentate, the first fraction, or both, are introduced and subjected to a temperature and a time necessary to kill microorganisms and to denature any undesirable enzymes to produce a sterile solid;
(d) a reverse osmosis (RO) device, wherein the permeate is introduced to standardize Brix and yield a RO permeate fraction comprising process water and a RO retentate fraction comprising standardized, substantially solid-free juice;
(e) at least one microorganism reduction device to sterilize the RO retentate fraction to produce a liquid that is sterile or otherwise has a substantially reduced bioburden, wherein the sterile liquid is the substantially solid-free final juice; and
(f) optionally, a recombiner for combining the sterile solid and the sterile liquid of (e) to produce a final juice comprising solids, wherein only the RO retentate fraction is introduced to the at least one microorganism reduction device to sterilize or reduce the bioburden of same to produce the sterilized RO retentate fraction for the final juice.

In an embodiment of the first aspect, a system for processing a raw juice feed to a final juice comprising solids is described, said system comprising:
(a) a large pulp separation device to separate the raw juice feed into a first fraction comprising large pulp and a second fraction, wherein wash water is introduced during separation to strip some or all of the first fraction of sugars and other desirable species, and wherein the second fraction comprises at least one of juice, fine pulp, wash water, sugars, and other desirables;
(b) at least one liquid-solid separation device to separate the second fraction into a permeate comprising the juice, wash water, sugars and other desirables and a retentate comprising the fine pulp, suspended solids, and non-suspended solids;
(c) a hot pasteurization device, wherein at least a portion of the retentate, the first fraction, or both, are introduced and subjected to a temperature and a time necessary to kill microorganisms and to denature any undesirable enzymes to produce a sterile solid;
(d) a reverse osmosis (RO) device, wherein the permeate is introduced to standardize Brix and yield a RO permeate fraction comprising process water and a RO retentate fraction comprising standardized, substantially solid-free juice;
(e) at least one microorganism reduction device to sterilize the RO retentate fraction to produce a liquid that is sterile or otherwise has a substantially reduced bioburden, wherein the sterile liquid is the substantially solid-free final juice; and
(f) a recombiner for combining the sterile solid and the sterile liquid of (e) to produce a final juice comprising solids, wherein only the RO retentate fraction is introduced to the at least one microorganism reduction device to sterilize or reduce the bioburden of same to produce the sterilized RO retentate fraction for the final juice.

In another embodiment of the first aspect, a system for processing a raw juice feed to a substantially solid-free final juice is described, said system comprising:
(a) a large pulp separation device to separate the raw juice feed into a first fraction comprising large pulp and a second fraction, wherein wash water is introduced during separation to strip some or all of the first fraction of sugars and other desirable species, and wherein the second fraction comprises at least one of juice, fine pulp, wash water, sugars, and other desirables;
(b) at least one liquid-solid separation device to separate the second fraction into a permeate comprising the juice, wash water, sugars and other desirables and a retentate comprising the fine pulp, suspended solids, and non-suspended solids;
(c) a reverse osmosis (RO) device, wherein the permeate is introduced to standardize Brix and yield a RO permeate fraction comprising process water and a RO retentate fraction comprising standardized, substantially solid-free juice; and
(d) at least one microorganism reduction device to sterilize the RO retentate fraction to produce a liquid that is sterile or otherwise has a substantially reduced bioburden, wherein the sterile liquid is the substantially solid-free final juice, wherein only the RO retentate fraction is introduced to the at least one microorganism reduction device to sterilize or reduce the bioburden of same to produce the sterilized RO retentate fraction for the final juice.

In a second aspect, a method of processing a raw juice feed to produce a final juice selected from the group consisting of a final juice comprising solids and a substantially solid-free final juice is described, said method comprising:
(a) separating the raw juice feed into a first fraction comprising large pulp and a second fraction, wherein wash water is introduced during the separation to strip some or all of the first fraction of sugars and other desirable species, and wherein the second fraction comprises at least one of juice, fine pulp, wash water, sugars, and other desirables;
(b) separating the second fraction into a permeate comprising the juice, wash water, sugars and other desirables and a retentate comprising the fine pulp, suspended solids, and non-suspended solids;
(c) optionally heating at least a portion of the retentate, the first fraction, or both, at a temperature and a time necessary to kill microorganisms and to denature any undesirable enzymes to produce a sterile solid;
(d) introducing the permeate to a reverse osmosis device to standardize Brix and yield a RO permeate fraction comprising process water and a RO retentate fraction comprising standardized, substantially solid-free juice;
(e) reducing the microorganism count of the RO retentate fraction to produce a liquid that is sterile or otherwise has a substantially reduced bioburden, wherein the sterile liquid is the substantially solid-free final juice; and
(f) optionally, recombining the sterile solid and the sterile liquid of (e) to produce a final juice comprising solids, wherein only the RO retentate fraction is introduced to the at least one microorganism reduction device to sterilize or reduce the bioburden of same to produce the sterilized RO retentate fraction for the final juice.

In an embodiment of the second aspect, a method of processing a raw juice feed to produce a final juice comprising solids is described, said method comprising:
(a) separating the raw juice feed into a first fraction comprising large pulp and a second fraction, wherein wash water is introduced during the separation to strip some or all of the first fraction of sugars and other desirable species, and wherein the second fraction comprises at least one of juice, fine pulp, wash water, sugars, and other desirables;
(b) separating the second fraction into a permeate comprising the juice, wash water, sugars and other desirables and a retentate comprising the fine pulp, suspended solids, and non-suspended solids;
(c) heating at least a portion of the retentate, the first fraction, or both, at a temperature and a time necessary to kill microorganisms and to denature any undesirable enzymes to produce a sterile solid;
(d) introducing the permeate to a reverse osmosis device to standardize Brix and yield a RO permeate fraction comprising process water and a RO retentate fraction comprising standardized, substantially solid-free juice;
(e) reducing the microorganism count of the RO retentate fraction to produce a liquid that is sterile or otherwise has a substantially reduced bioburden, wherein the sterile liquid is the substantially solid-free final juice; and
(f) recombining the sterile solid and the sterile liquid of (e) to produce a final juice comprising solids, wherein only the RO retentate fraction is introduced to the at least one microorganism reduction device to sterilize or reduce the bioburden of same to produce the sterilized RO retentate fraction for the final juice.

In another aspect of the second aspect, a method of processing a raw juice feed to produce a substantially solid-free final juice is described, said method comprising:
(a) separating the raw juice feed into a first fraction comprising large pulp and a second fraction, wherein wash water is introduced during the separation to strip some or all of the first fraction of sugars and other desirable species, and wherein the second fraction comprises at least one of juice, fine pulp, wash water, sugars, and other desirables;
(b) separating the second fraction into a permeate comprising the juice, wash water, sugars and other desirables and a retentate comprising the fine pulp, suspended solids, and non-suspended solids;
(c) introducing the permeate to a reverse osmosis device to standardize Brix and yield a RO permeate fraction comprising process water and a RO retentate fraction comprising standardized, substantially solid-free juice; and
(d) reducing the microorganism count of the RO retentate fraction to produce a liquid that is sterile or otherwise has a substantially reduced bioburden, wherein the sterile liquid is the substantially solid-free final juice, wherein only the RO retentate fraction is introduced to the at least one microorganism reduction device to sterilize or reduce the bioburden of same to produce the sterilized RO retentate fraction for the final juice.

With regards to the system and method described herein, (i) the permeate stream is not subjected to evaporative concentration, (ii) none of the liquids or solids are exposed to activated carbon, zeolite, or a resin, and (iii) the viscosity of the final juice is not reduced using highly propagating ultrasonic energy, (iv) there is no enzymatic or mechanical pretreatment, (v) no consumable chemicals are added to depectinize, (vi) there is no separate depectinization step, and (vii) no ion-exchange columns are needed to adjust the concentration of any of the species in the juice. In the present system and process, the pectin is captured as a retentate in the filtration devices described herein, which do not succumb to the disadvantages of the prior art relating to pectin clogging.

The system and method of using same described herein can be practiced continuously or in batches, as readily understood by the person skilled in the art. For example, for each individual device of the system described herein, e.g., cross-flow filtration device, reverse osmosis device, etc., one or more additional and identical devices may be arranged in parallel. For example, following passage through the separation device, there can be at least two, three, four, five, six, seven, eight, nine, ten, or more, identical systems arranged in parallel, which permits the central automation system to clean one system while the other systems remain operational, ensuring continuous processing.

The advantages of the present method/system described herein are numerous including, but not limited to and in no particular order:
the ability to consistently engineer a preferred final juice including, but not limited to: individual components can be isolated for removal and/or recombining in non-naturally occurring ratios (e.g., the removal of undesirable species such as lactose, acids, some or all sugars); Brix can be increased or decreased regardless of the season to produce a consistent product year-round; the concentration of solids such as pulp, if any is desired, can be adjusted; the color of the final juice can be adjusted; naturally-occurring organic dyes (e.g., from beet root) can be isolated;
when processing orange juice using the system and method described herein, linalool and acetic acid pass into the permeate. Therefore, they are not pasteurized together and the final juice is substantially devoid of linalool acetate;
the shelf-life of the final juice can be extended without having to add preservatives thereto. In some embodiments, the final juice has a similar quality to the raw juice feed, i.e., fresh squeezed juice, after about 30 days, or after about 60 days, or after about 90 days post-processing of the raw juice feed;
the prevention of phase separation. Because the principal flavor and aroma constituents are in the sterile liquid, should a producer decide not to add back the pasteurized solids, the substantially solid-free juice can be offered without the need to “shake before opening” because no suspendable solids will be present in the final juice;
the method and system can be integrated and controlled by central automation in a single unit system;
the final juice is substantially devoid of flavor and aroma packs;
there is no need to add heat sensitive nutrients, such as Vitamin C, to the final juice prior to packaging. The system and method described herein includes a diafiltration step that captures many heat sensitive nutrients such as Vitamin C (e.g., potassium, carotenoids, flavonoids, and other phytoactive compounds) in the permeate, for eventual passage to the sterile or bioburden reduction filter, instead of the pasteurizer where denaturization can occur;
the final juice obtained using the system and method described herein our has been shown to have no discernable deterioration of flavor or aroma for at least 60 days, even without refrigeration;
the method can be substantially waste free;
the system/method can be adjusted and applied to any fruit or vegetable. Once the desirable/undesirable components and other goals are identified, a series of cuts can be made to isolate and remove or adjust the levels to the desired final juice;
components can be added to the final juice as desired by consumers including, but not limited to, at least one of prebiotics, probiotics, fiber enhancers, vitamin D, DHA/EPA and calcium;
the final juice processed using the system and method described herein is preferably substantially devoid of bacteria and other microorganisms because of the combination of sterile filtration of the liquid and heat pasteurization of the solid, enabling shelf-life extension, as well as permitting the decrease or removal of refrigeration requirements without a significant loss of quality;
because the permeate comprises the flavor and aroma components, which are not subjected to pasteurization, the final juice can substantially maintain its original flavor and aroma.

An embodiment of the system and method described herein

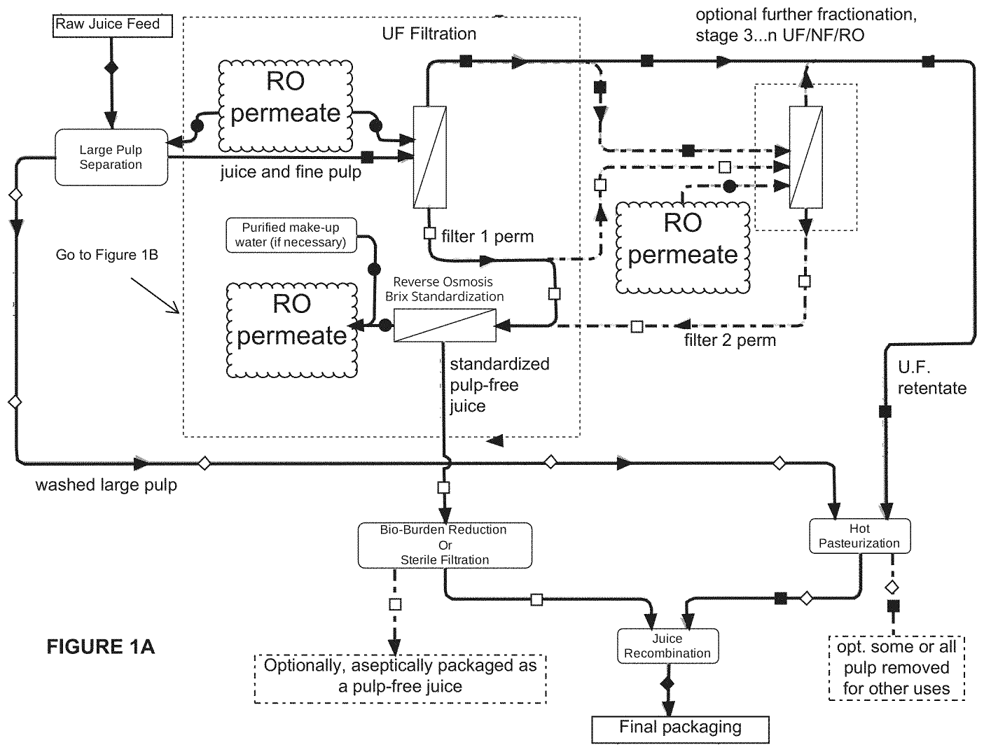

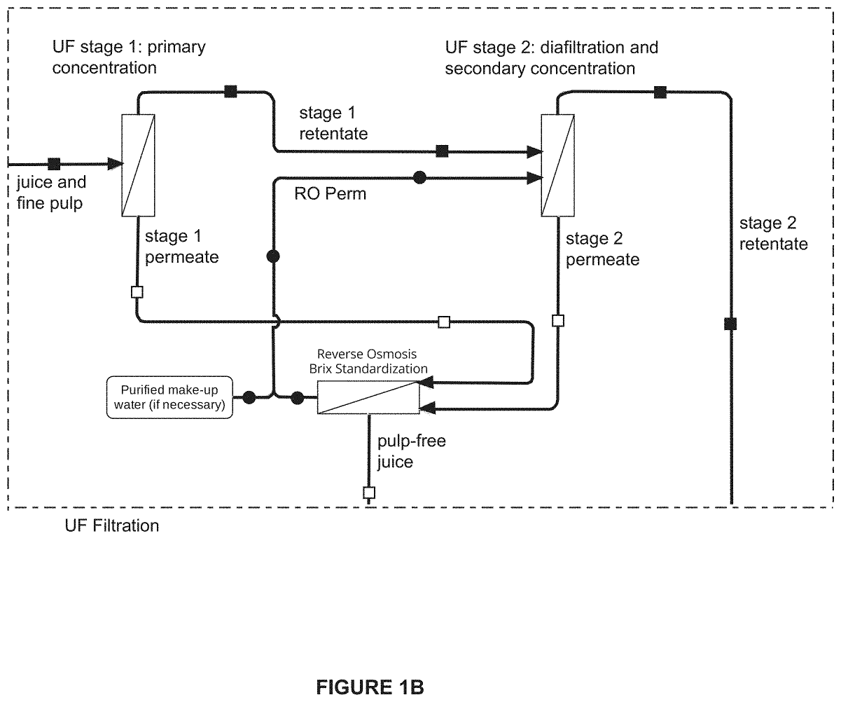

An embodiment of the system and method described herein is shown in FIGS. 1A and 1B and described below. For ease of reference, the boxes labeled “RO permeate” corresponds to a RO permeate outlet/diafiltration feed and in practice are communicatively interconnected. In some embodiments, there is no storage container for the RO permeate, just communicatively connected conduits. In some embodiments, there is at least one storage container for the RO permeate, in addition to the communicatively connected conduits. For ease of reference, the dashed lines between components indicate optional processing. FIG. 1B is a blown-up view of the dashed box in FIG. 1A.
A large pulp separation device is used to separate large pulp from liquid and fine/small pulp in a raw feed juice. In one embodiment, the large pulp is washed with water (e.g., Reverse Osmosis (RO) permeate water (labeled as “RO permeate”) preferably generated from within the process, as discussed hereinbelow) at the large pulp separation device. Washed large pulp from the large pulp separation device is moved (a) to hot pasteurization if the intent is to include some or all of the large pulp solid phases in the final juice, or (b) if the intent is to not include some or all of the large pulp solid phases in the final juice, to further processing (not shown), e.g., as filler, animal feed. The juice and fine/small pulp is moved to Filter stage 1. Large pulp separation devices include, but are not limited to, screen separators, centrifuges, strainers, decanters, finishers, vibratory finishers, or equivalents thereof. Advantageously, washing the large pulp with the RO permeate water maximizes the amount of sugars and desirables removed from the large pulp, thereby ensuring less sugar and desirables are passed through to the heat pasteurization device in the large pulp solid fraction. The large pulp separation device also facilitates the process's ability to produce a final product having the same volume and proportions of sugar, suspended solids, etc. Importantly, the washed large pulp is never moved directly to an ultrafiltration device, e.g., a cross-flow filtration device, which will break down the large pulp and change the mouthfeel of the final product, as well as decrease the efficiency of the method because the washed large pulp will clog the ultrafiltration device.
Filter Stage 1: Filter stage 1 is where the primary concentration happens. Filter stage 1 comprises at least one of a microfiltration (MF) device, a nanofiltration (NF) device, an ultrafiltration (UF) device, or a RO device. In some embodiments, filter stage 1 comprises at least one MF/UF filtration device such as an open channel tangential cross-flow filtration cassette device as described hereinbelow. In some embodiments, the stage 1 filter can use hollow fiber, tubular, ceramics, or other open plate and frame technologies. Regardless of the filtration device used, the membrane cut-off and process conditions can be chosen to ensure specific components are retained or passed as necessary and the device can be readily cleaned. For example, the cross-flow filtration cassette as described hereinbelow enables cleaning-in-place to remove fouling species such as pectin. Although not shown, two or more (e.g., 3, 4, 5, or more) stage 1 filter devices can be arranged in parallel. The at least one stage 1 filter device retains small pulp and other suspended solids in the stage 1 retentate and a juice that is substantially free of suspended solids in the stage 1 permeate. The intent of the stage 1 filter is to separate out a juice that is substantially free of suspended solids as the stage 1 permeate which can then be filter sterilized instead of heat pasteurized, thus permitting the stage 1 permeate to retain most of the fresh-squeezed flavor and aroma profile. In some embodiments, a MF/UF Filter, ranging from 1 μm to 1 kDa, is used, as readily understood by the person skilled in the art, to separate suspended solids from liquids as well as to obtain specific fractions. Although not shown, it should be appreciated that the Stage 1 filter can further comprise a recirculation loop and/or can include diafiltration. After filtration, the stage 1 retentate can be moved to (a) Stage 2 Diafiltration and Secondary Concentration, (b) hot pasteurization, (c) for further processing (not shown), e.g., as filler, animal feed, or (d) some combination of (a)-(c). For example, in some embodiments, the final juice may be intended to be substantially solid-free and the stage 1 retentate can be sent to further processing. In other embodiments, the final juice is intended to contain some solid, e.g., pulp, in which case the stage 1 retentate is moved to (a) Stage 2 Diafiltration and Secondary Concentration, and/or (b) hot pasteurization. After filtration, the stage 1 permeate is moved to Reverse Osmosis Brix standardization.
Optional Filter Stage 2: Filter stage 2, when included, is a secondary concentrator with diafiltration. Filter stage 2 comprises at least one of a microfiltration (MF) device, a nanofiltration (NF) device, an ultrafiltration (UF) device, or a RO device. In some embodiments, filter stage 2 comprises at least one MF/UF filtration device such as an open channel tangential cross-flow filtration cassette as described hereinbelow. In some embodiments, the stage 2 filter can use hollow fiber, tubular, ceramics, or other open plate and frame technologies. Regardless of the filtration device used, the membrane cut-off and process conditions can be chosen to ensure specific components are retained or passed as necessary and the device can be readily cleaned. For example, the cross-flow filtration cassette as described hereinbelow enables cleaning-in-place to remove fouling species such as pectin. Although not shown, two or more (e.g., 3, 4, 5, or more) stage 2 filter devices can be arranged in parallel. In filter stage 2, the stage 1 retentate comprising small pulp and other suspended solids is washed with water, e.g., RO permeate water (labeled as “RO permeate”) preferably generated from within the process. The intent of stage 2 filter is to further wash the small pulp and suspended solids in the stage 1 retentate to ensure the sugars and vitamins are incorporated into the stage 2 permeate. This can be accomplished in part by stripping or further breaking open the pulp, using shear in the stage 2 filter device, to ensure all desirables are washed through to the stage 2 permeate. In some embodiments, a MF/UF Filter, ranging from 1 μm to 1 kDa, is used, as readily understood by the person skilled in the art, to separate suspended solids from liquids as well as to obtain specific fractions. Although not shown, it should be appreciated that the Stage 2 filter can further comprise a recirculation loop. After filtration, washed stage 2 retentate can then be moved to (a) hot pasteurization if the intent is to include the fine/small solid phases in the final juice, or (b) to further processing (not shown), e.g., as filler, animal feed, if the intent is to not include some or all of the fine/small solid phases in the final juice. After filtration, the stage 2 permeate, which can contain, for example, sugars and vitamins, is moved to Reverse Osmosis Brix standardization.
Reverse Osmosis Brix Standardization device. The at least one RO device permits the standardization of the stage 1, and optional stage 2 (if obtained), permeate to a pre-determined preferred or standardized Brix level. Although not shown, two or more (e.g., 3, 4, 5, or more) RO devices can be arranged in parallel. Standardized retentate fluids from the at least one RO device, which comprise the substantially solid-free juice, are bled off and moved to sterile filtration. Permeated fluids (i.e., RO permeate) from the RO device can be directed to, and reutilized as wash water in, the large pulp separation device and/or the stage 1 filter/diafiltration device and/or the stage 2 filter/diafiltration device. In some embodiments, there is no storage container for the RO permeate, and instead the RO permeate is just communicatively connected, e.g., via conduits, to the large pulp separation device and the stage 1 filter/diafiltration device and the stage 2 filter/diafiltration device. In some embodiments, there is at least one storage container for the RO permeate, in addition to the communicatively connected conduits to the large pulp separation device and the stage 1 filter/diafiltration device and the stage 2 filter/diafiltration device. In some embodiments, additional water needs to be added to the system and process, wherein the water can be added anywhere between the at least one RO device and the large pulp separation device and the stage 1 filter/diafiltration device and the stage 2 filter/diafiltration device. The intent of the at least one RO device is to allow the user to standardize the Brix level of the final juice. For example, the Brix level can be adjusted to match that of the starting raw feed juice or some other target set by the juice manufacturer to provide the highest flavor quality.
Sterile or Bioburden Reduction Filtration (e.g., dead end membrane filter or equivalent thereof). The RO retentate comprising standardized (i.e., Brix level) juice substantially free of solids is then filter sterilized or undergoes bioburden reduction, as understood by the person skilled in the art, to produce a sterile liquid. The entire volume, less the removed microorganisms, permeates the sterile filter (and/or bioburden reduction filter) and (a) passes to the final juice re-combination tank, or (b) if the final juice is intended to be substantially solid-free, aseptically packaged as is. In one embodiment, only RO retentate from the Reverse Osmosis Brix Standardization device undergoes sterile and/or bioburden reduction filtration for the final juice. In other words, at no point is permeate from the filter stage devices or the large pulp separation device passed directly to the to the sterile and/or bioburden reduction filtration device. Instead, the permeate from the large pulp separation device and the filter stage devices passes through the RO Brix standardization device prior to passage to the sterile and/or bioburden reduction filtration device.
Hot Pasteurization. In some embodiments, where pulp and other solids are intended to be present in the final juice, heat is used to pasteurize at least one of: the washed large pulp from large pulp separator device; the stage 1 retentate; the stage 2 retentate; retentate from the optional additional stages; or some combination thereof, to produce a sterile solid fraction. In some embodiments, once heat pasteurization targets are met, some or all of the volume of solid passes to the final juice re-combination tank. The heat pasteurization step can be optional, meaning that if the final juice is intended to be substantially free of solids, i.e., substantially solid-free, the solids that normally would pass to heat pasteurization can be re-routed to other uses. In some embodiments, very little of the liquid present in the initial raw juice feed (including the liquid present in the pulp) goes through the heat pasteurization process to minimize the impact of the heat on the desirables such as flavor and aroma quality. In some embodiments, less than 5% of the liquid present in the initial raw juice feed (including the liquid present in the pulp) goes through the heat pasteurization process using the system and method described herein. In other embodiments, less than 1% of the liquid present in the initial raw juice feed (including the liquid present in the pulp) goes through the heat pasteurization process using the system and method described herein. In still other embodiments, less than 0.5% of the liquid present in the initial raw juice feed (including the liquid present in the pulp) goes through the heat pasteurization process using the system and method described herein.
Juice Recombination. When the final juice is intended to comprise a solid, e.g., pulp and other solids, the sterile liquid from the Sterile or Bioburden Reduction Filtration device is combined with the sterile solid fraction from the Hot Pasteurization device to yield a recombined final juice.
Final packaging. The final juice is dispensed into final containers or packages for commercial and retail sales. In some embodiments, the final packaging comprises an aseptic process to ensure that no organisms are introduced to the final juice post processing. This is important to both the flavor, aroma quality and shelf life. In some embodiments, the final juice is stored in darkness and/or a container that minimizes the exposure of the juice to light.
Optional step/components. Although not shown, in some embodiments, at least a portion of the stage 1 and/or the stage 2 (and/or stage 3) retentate fraction may be removed from the system/method for other uses, for example, as a natural dye.

Another Embodiment of the System and Method Described Herein

Another set of embodiments of the system and method described herein are shown in FIGS. 2A-2D and described below. For ease of reference, the boxes labeled “RO permeate” corresponds to a RO permeate outlet/diafiltration feed and in practice are communicatively interconnected. In some embodiments, there is no storage container for the RO permeate, just communicatively connected conduits. In some embodiments, there is at least one storage container for the RO permeate, in addition to the communicatively connected conduits. For ease of reference, the dashed lines between components indicate optional processing.
A large pulp separation device is used to separate large pulp from liquid and fine/small pulp in a raw feed juice. In one embodiment, the large pulp is washed with water (e.g., Reverse Osmosis (RO) permeate water (labeled as “RO permeate”) preferably generated from within the process, as discussed hereinbelow) at the large pulp separation device. Washed large pulp from the large pulp separation device is moved (a) to hot pasteurization if the intent is to include some or all of the large pulp solid phases in the final juice, or (b) if the intent is to not include some or all the large pulp solid phases in the final juice, to further processing (not shown), e.g., as filler, animal feed. The juice and fine/small pulp is moved to Filter stage 1. Large pulp separation devices include, but are not limited to, screen separators, centrifuges, strainers, decanters, finishers, vibratory finishers, or equivalents thereof. Advantageously, washing the large pulp with the RO permeate water maximizes the amount of sugars and desirables removed from the large pulp, thereby ensuring less sugar and desirables are passed through to the heat pasteurization device in the large pulp solid fraction. The large pulp separation device also facilitates the process's ability to produce a final product having the same volume and proportions of sugar, suspended solids, etc. Importantly, the washed large pulp is never moved directly to an ultrafiltration device, e.g., a cross-flow filtration device, which will break down the large pulp and change the mouthfeel of the final product, as well as decrease the efficiency of the method because the washed large pulp will clog the ultrafiltration device.
Filter Stage 1: Filter stage 1 is where the primary concentration happens. Filter stage 1 comprises at least one of a microfiltration (MF) device, a nanofiltration (NF) device, an ultrafiltration (UF) device, or a RO device. In some embodiments, filter stage 1 comprises at least one MF/UF filtration device such as an open channel tangential cross-flow filtration cassette device as described hereinbelow. In some embodiments, the stage 1 filter can use hollow fiber, tubular, ceramics, or other open plate and frame technologies. Regardless of the filtration device used, the membrane cut-off and process conditions can be chosen to ensure specific components are retained or passed as necessary and the device can be readily cleaned. For example, the cross-flow filtration cassette as described hereinbelow enables cleaning-in-place to remove fouling species such as pectin. Although not shown, two or more (e.g., 3, 4, 5, or more) stage 1 filter devices can be arranged in parallel. The at least one stage 1 filter device retains small pulp and other suspended solids in the stage 1 retentate and a juice that is substantially free of suspended solids in the stage 1 permeate. The intent of the stage 1 filter is to separate out a juice that is substantially free of suspended solids as the stage 1 permeate which can then be filter sterilized instead of heat pasteurized, thus permitting the stage 1 permeate to retain most of the fresh-squeezed flavor and aroma profile. In some embodiments, a MF/UF Filter, ranging from 1 μm to 1 kDa, is used, as readily understood by the person skilled in the art, to separate suspended solids from liquids as well as to obtain specific fractions. Although not shown, it should be appreciated that the Stage 1 filter can further comprise a recirculation loop. Following filtration, the stage 1 retentate can be moved to Stage 2 Diafiltration and Secondary Concentration. For example, in some embodiments, the final juice may be intended to be substantially solid-free and the stage 1 retentate can be sent to further processing. In other embodiments, the final juice is intended to contain some solid, e.g., pulp, in which case the stage 1 retentate is moved to (a) Stage 2 Diafiltration and Secondary Concentration, and/or (b) hot pasteurization. After filtration, the stage 1 permeate which can contain, for example, sugars and vitamins, is moved to (a) Reverse Osmosis Brix standardization (e.g., FIGS. 2A and 2B), or (b) further fractionation to separate additional enzymes for inactivation out of the combined permeates (e.g., FIG. 2C).
Filter Stage 2: FIGS. 2A-2C include filter stage 2 for sugar and fluid removal and secondary concentration and diafiltration. Filter stage 2 comprises at least one of a microfiltration (MF) device, a nanofiltration (NF) device, an ultrafiltration (UF) device, or a RO device. In some embodiments, filter stage 2 comprises at least one MF/UF filtration device such as an open channel tangential cross-flow filtration cassette as described hereinbelow. In some embodiments, the stage 2 filter can use hollow fiber, tubular, ceramics, or other open plate and frame technologies. Regardless of the filtration device used, the membrane cut-off and process conditions can be chosen to ensure specific components are retained or passed as necessary and the device can be readily cleaned. For example, the cross-flow filtration cassette as described hereinbelow enables cleaning-in-place to remove fouling species such as pectin. Although not shown, two or more (e.g., 3, 4, 5, or more) stage 2 filter devices can be arranged in parallel. In filter stage 2, the retentate from stage 1 comprising small pulp and other suspended solids is washed with water, e.g., RO permeate water (labeled as “RO permeate”) preferably generated from within the process. The intent of stage 2 filter is to further wash the small pulp and suspended solids in the stage 1 retentate to ensure the sugars and vitamins are incorporated into the stage 2 permeate. This can be accomplished in part by stripping or further breaking open the pulp, using shear in the stage 2 filter device, to ensure all desirables are washed through to the stage 2 permeate. In some embodiments, a MF/UF Filter, ranging from 1 μm to 1 kDa, is used, as readily understood by the person skilled in the art, to separate suspended solids from liquids as well as to obtain specific fractions. Although not shown, it should be appreciated that the Stage 2 filter can further comprise a recirculation loop. After filtration, washed stage 2 retentate can (a) be moved to hot pasteurization if the intent is to include the fine/small solid phases in the final juice (i.e., FIG. 2A), (b) be moved to further processing, e.g., as filler, animal feed, if the intent is to not include some or all of the fine/small solid phases in the final juice (not shown), (c) be combined with the stage 1 retentate for reintroduction into the stage 2 filter (i.e., recirculation) (not shown), (d) be moved to further fractionation, e.g., for enzyme removal and denaturing, (see, FIG. 2B), (e) some combination of (a) and (c), (f) some combination of (b) and (c) or (g) some combination of (c) and (d). After filtration, the stage 2 permeate, which can contain, for example, sugars and vitamins, is moved to (a) Reverse Osmosis Brix standardization (e.g., FIGS. 2A and 2B), or (b) further fractionation to separate additional enzymes for inactivation out of the combined permeates (e.g., FIG. 2C).
Optional Filter Stage 3. FIG. 2B includes filter stage 3 for further fractionation, e.g., enzyme removal and optional denaturing. Filter stage 3 comprises at least one of a microfiltration (MF) device, a nanofiltration (NF) device, an ultrafiltration (UF) device, or a RO device. In some embodiments, filter stage 3 comprises at least one MF/UF filtration device such as an open channel tangential cross-flow filtration cassette as described hereinbelow. In some embodiments, the stage 3 filter can use hollow fiber, tubular, ceramics, or other open plate and frame technologies. Regardless of the filtration device used, the membrane cut-off and process conditions can be chosen to ensure specific components are retained or passed as necessary and the device can be readily cleaned. For example, the cross-flow filtration cassette as described hereinbelow enables cleaning-in-place to remove fouling species such as pectin. Although not shown, two or more (e.g., 3, 4, 5, or more) stage 3 filter devices can be arranged in parallel. In filter stage 3, the retentate from stage 2 is further washed with water, e.g., RO permeate water (labeled as “RO permeate”) preferably generated from within the process. The intent of stage 3 filter is to further fractionate compounds such as enzymes from the stage 2 retentate to ensure they are incorporated into the stage 3 permeate. In some embodiments, a MF/UF Filter, ranging from 1 μm to 1 kDa, is used, as readily understood by the person skilled in the art, to obtain specific fractions from the stage 2 retentate. Although not shown, it should be appreciated that the Stage 3 filter can further comprise a recirculation loop. After filtration, washed stage 3 retentate can (a) be moved to hot pasteurization if the intent is to include the fine/small solid phases in the final juice, or (b) be moved to further processing, e.g., as filler, animal feed, if the intent is to not include some or all of the fine/small solid phases in the final juice (not shown). After filtration, the stage 3 permeate is moved to Reverse Osmosis Brix standardization, optionally after heat denaturing of the enzymes contained in the stage 3 permeate. In some embodiment, the stage 3 permeate comprising at least one enzyme is moved directly to RO Brix standardization without heat denaturing.
Optional Filter Stage 4. FIG. 2C includes filter stage 4 for further fractionation, e.g., enzyme removal from the stage 2 permeate. In some embodiments, filter stage 4 may be useful if the intent is to adjust a percentage of a component present in the permeate prior to introduction to the RO Brix standardization device. Filter stage 4 comprises at least one of a microfiltration (MF) device, a nanofiltration (NF) device, an ultrafiltration (UF) device, or a RO device. In some embodiments, filter stage 4 comprises at least one MF/UF filtration device such as an open channel tangential cross-flow filtration cassette as described hereinbelow. In some embodiments, the stage 4 filter can use hollow fiber, tubular, ceramics, or other open plate and frame technologies. Regardless of the filtration device used, the membrane cut-off and process conditions can be chosen to ensure specific components are retained or passed as necessary and the device can be readily cleaned. For example, the cross-flow filtration cassette as described hereinbelow enables cleaning-in-place to remove fouling species such as pectin. Although not shown, two or more (e.g., 3, 4, 5, or more) stage 4 filter devices can be arranged in parallel. In filter stage 4, the permeate from stage 2 is further fractionated to remove, for example, enzymes from the stage 2 permeate. In some embodiments, a MF/UF Filter, ranging from 1 μm to 1 kDa, is used, as readily understood by the person skilled in the art, to obtain specific fractions from the stage 2 permeate. Although not shown, it should be appreciated that the Stage 4 filter can further comprise a recirculation loop. After filtration, the stage 4 retentate can (a) be moved to hot pasteurization, or (b) be moved to further processing, e.g., as filler, animal feed (not shown). After filtration, the stage 4 permeate is moved to Reverse Osmosis Brix standardization.
Reverse Osmosis Brix Standardization device. The at least one RO device permits the standardization of the stage 1, stage 2, stage 3 (when obtained), and stage 4 permeate (when obtained) to a pre-determined preferred Brix level. Although not shown, two or more (e.g., 3, 4, 5, or more) RO devices for Brix standardization can be arranged in parallel. Standardized retentate fluids from the at least one RO device, which comprise the substantially solid-free juice, are bled off and moved to sterile filtration. Permeated fluids (i.e., RO permeate) from the RO device can be directed to, and reutilized as wash water in, the large pulp separation device and/or the stage 1 filter/diafiltration device and/or the stage 2 filter/diafiltration device (and/or nth stage filter/diafiltration device). In some embodiments, there is no storage container for the RO permeate, and instead the RO permeate is just communicatively connected, e.g., via conduits, to the large pulp separation device and the stage 1 filter/diafiltration device and the stage 2 filter/diafiltration device (and the nth stage filter/diafiltration device). In some embodiments, there is at least one storage container for the RO permeate, in addition to the communicatively connected conduits to the large pulp separation device and the stage 1 filter/diafiltration device and the stage 2 filter/diafiltration device (and the nth stage filter/diafiltration device). In some embodiments, additional water needs to be added to the system and process, wherein the water can be added anywhere between the at least one RO device and the large pulp separation device and the stage 1 filter/diafiltration device and the stage 2 filter/diafiltration device (and the nth stage filter/diafiltration device). The intent of the at least one RO device is to allow the user to standardize the Brix level of the final juice. For example, the Brix level can be adjusted to match that of the starting raw feed juice or some other target set by the juice manufacturer to provide the highest flavor quality.
Sterile or Bioburden Reduction Filtration (e.g., dead end membrane filter or equivalent thereof). The RO retentate comprising standardized (i.e., Brix level) juice substantially free of solids is then filter sterilized or undergoes bioburden reduction, as understood by the person skilled in the art, to produce a sterile liquid. The entire volume, less the removed microorganisms, permeates the sterile filter (and/or bioburden reduction filter) and (a) passes to the final juice re-combination tank, or (b) if the final juice is intended to be substantially solid-free, aseptically packaged as is. In one embodiment, only RO retentate from the Reverse Osmosis Brix Standardization device undergoes sterile and/or bioburden reduction filtration for the final juice. In other words, at no point is permeate from the large pulp separation device and the filter stage devices passed directly to the to the sterile or bioburden reduction filtration device. Instead, the permeate from the large pulp separation device and the filter stage devices passes through the RO Brix standardization device prior to passage to the sterile and/or bioburden reduction filtration device.
Hot Pasteurization. In some embodiments, where pulp and other solids is intended to be present in the final juice, heat is used to pasteurize at least one of: the washed large pulp from large pulp separator device; the stage 1 retentate; the stage 2 retentate; the stage 3 retentate (if obtained), the stage 4 retentate (if obtained); or some combination thereof, to produce a sterile solid fraction. In some embodiments, once heat pasteurization targets are met, some or all of the solid passes to the final juice re-combination tank. The heat pasteurization step can be optional, meaning that if the final juice is intended to be substantially free of solids, i.e., substantially solid-free, the solids that normally would pass to heat pasteurization can be re-routed to other uses. In some embodiments, very little of the liquid present in the initial raw juice feed (including the liquid present in the pulp) goes through the heat pasteurization process, thereby minimizing the impact of the heat on the desirables such as flavor and aroma quality. In some embodiments, less than 5% of the liquid present in the initial raw juice feed (including the liquid present in the pulp) goes through the heat pasteurization process using the system and method described herein. In other embodiments, less than 1% of the liquid present in the initial raw juice feed (including the liquid present in the pulp) goes through the heat pasteurization process using the system and method described herein. In still other embodiments, less than 0.5% of the liquid present in the initial raw juice feed (including the liquid present in the pulp) goes through the heat pasteurization process using the system and method described herein.
Juice Recombination. When the final juice is intended to comprise a solid, e.g., pulp and other solids, the sterile liquid from the Sterile or Bioburden Reduction Filtration device is combined with the sterile solid fraction from the Hot Pasteurization device to yield a recombined final juice.
Final packaging. The final juice is dispensed into final containers or packages for commercial and retail sales. In some embodiments, the final packaging comprises an aseptic process to ensure that no organisms are introduced to the final juice post processing. This is important to both the flavor, aroma quality and shelf life. In some embodiments, the final juice is stored in darkness and/or a container that minimizes the exposure of the juice to light.

Cross-Flow Filtration Devices

For the purposes of the present disclosure, cross-flow filtration devices include, for example, those as manufactured by Smartflow Technologies, Inc., Sanford, N.C., USA and variously described in the following United States patents: U.S. Pat. Nos. 4,867,876; 4,882,050; 5,034,124; 5,034,124; 5,049,268; 5,232,589; 5,342,517; 5,593,580; 5,868,930; 10,987,631; and U.S. patent application Ser. No. 17/379,337 filed on Jul. 19, 2021 in the name of Todd Benson, et al., and entitled “Filter Cassette Article, and Filter Comprising Same”; the disclosures of all of which are hereby incorporated herein by reference in their respective entireties. An embodiment of a cross-flow filtration device is further described hereinbelow.

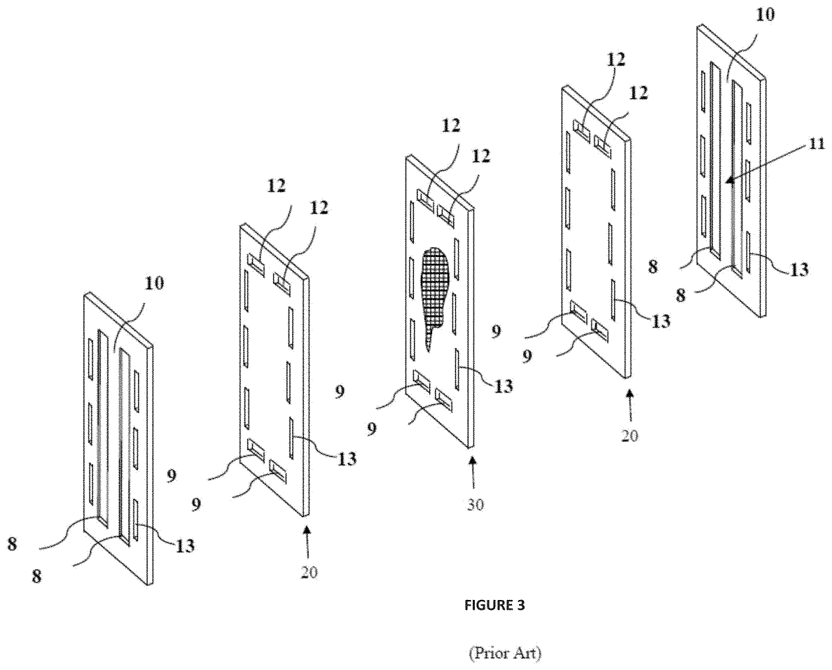

Briefly, a generalized embodiment of a cross-flow filtration cassette is shown in FIG. 3, said filtration cassette comprising at least one assembly, wherein the at least one assembly comprises a multilaminate array of sheet members of generally rectangular and generally planar shape with main top and bottom surfaces and a first end and a second end along the longitudinal axis, wherein the sheet members include in sequence in said array a first assembly end plate (not shown), a first retentate sheet (10), a first filter sheet (20), a permeate sheet (30), a second filter sheet (20), a second retentate sheet (10), and a second assembly end plate (not shown), wherein each of the assembly end plate, permeate sheet members, and filter sheet members in said array have at least one retentate cutout opening (9) at a first end thereof, and at least one retentate cutout opening (12) at opposite second end thereof, with permeate passage openings (13) at longitudinal side margin portions of the sheet members. Each of the first and second retentate sheets (10) have at least one channel opening (8) therein, extending longitudinally between the first end retentate (9) and second end retentate (12) openings of the permeate and filter sheets in the array. The sheets are bonded (e.g., compression, adhesive, or both) to adjacent sheets about peripheral end and side portions thereof, with their retentate cutout openings and permeate passage openings in register with one another, wherein a central portion of each of the sheets is unbonded to permit liquid source material to flow down the channel opening(s) such that permeate flows through the filter sheet (20) to the permeate sheet (30), and to permit the permeate in the permeate sheet (30) to flow towards the permeate passage openings to the permeate outlet. For ease of disclosure, the first end retentate (9) and second end retentate openings (12) (and permeate passage openings (13)) are illustrated in FIG. 3 as generally rectangular or square but can be an irregular pentagon. It should be appreciated by the person skilled in the art that the shape of the retentate openings (and permeate passage openings) are not limited to rectangles or squares or irregular pentagons and can include any other reasonable shape for the flow of fluid therethrough, as readily understood by the person skilled in the art. Two assembly end plates sandwich the multilaminate array of sheets, wherein the two assembly end plates comprise at least one fluid opening at the first end thereof, and at least one fluid opening at the second end thereof, or both, in register with the fluid openings of the array. In addition, the at least one assembly can further comprise at least one of options (I), (II), (III), or (IV), or any combination of (I)-(IV): (I) a cap positioned on at least a portion of the first end fluid opening(s) or at least a portion of the second end fluid opening(s), or both, of a permeate pack, wherein the permeate pack comprises the first filter sheet, the permeate sheet, and the second filter sheet members, wherein the cap is positioned proximate to the channel openings of the first and second retentate sheets; (II) the fluid openings at the first end, the fluid openings at the second end, or both the fluid openings at the first and second end, are cut as an irregular pentagon having a “V” positioned proximate to the channel openings of the first and second retentate sheets; (III) a first permeate screen spacer positioned between the first filter sheet and the permeate sheet or a second permeate screen spacer positioned between the second filter sheet and the permeate sheet, or both, wherein the permeate screen spacer(s) comprise fluid openings in register with the fluid openings of the array; (IV) the permeate sheet comprises a metal matrix or other reinforced porous material of requisite thickness.

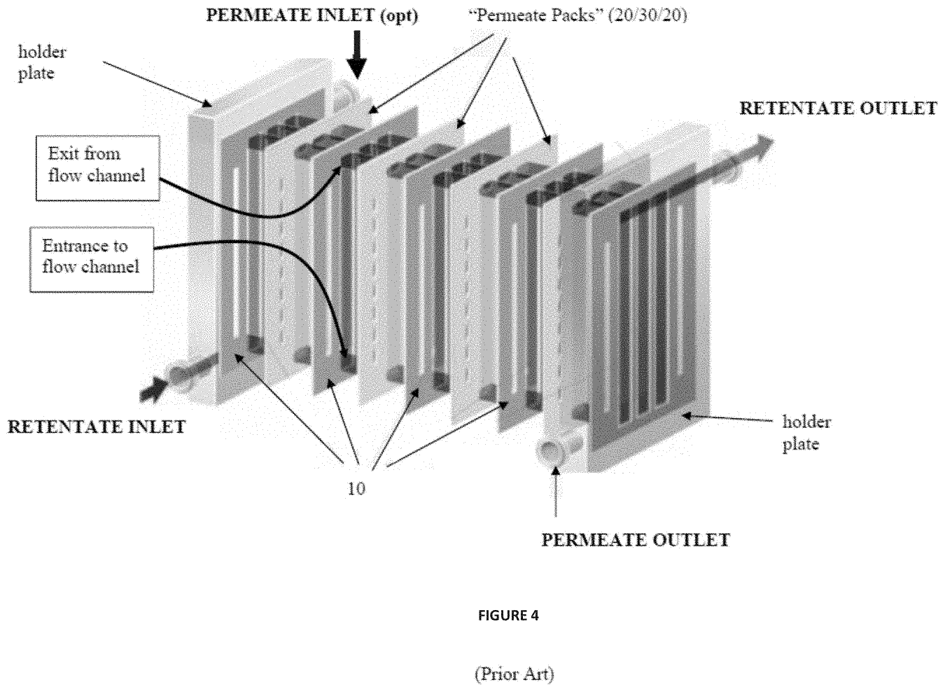

The cross-flow filtration cassettes can be mounted between holder plates, which may be provided with suitable ports, for introduction of liquid source material to be separated in the cassettes, and for discharge or withdrawal of filtrate/permeate and retentate (see, e.g., FIG. 4). One skilled in the art can appreciate that the assembly end plates can be integrally sealed to the assembly of sheets to have a single module comprised of assembly end plates and at least one assembly of sheets. If the integrally sealed assembly end plates are of plastic or polymeric materials or sheets, the units may provide the function of a disposable device for single or multiple use.

In the use of cross-flow filtration cassettes, the specificity and speed of a desired separation is effected by a number of factors including, but not limited to, a) fluid distribution in the cross-flow module, b) channel height of the cross-flow module, c) channel length, d) shear rate, e) sheet pore structure, f) sheet structure, g) sheet chemistry, h) trans-membrane pressure, i) osmotic force, j) hydrophobic/hydrophilic differential, k) liquid source material modification, l) temperature, and m) pressure drop, which is a function of applied pressure channel length, velocity and solution viscosity.

For use in the present apparatus and method, the pore size of the filter sheets are selected to ensure that the specific targeted material, e.g., fine pulp, do not pass through the filter sheets during filtration, i.e., do not pass through the filter sheet and enter the permeate stream, as readily determined by the person skilled in the art. The pore size can also be selected to isolate species such as enzymes from solids, e.g., fine pulp, as understood by the person skilled in the art.

It is well known in the art that there can be benefits to working with a higher temperature fluid because the viscosity of the fluid can decrease as the temperature increases. As a result, the permeate flux passage is improved with a concomitant decrease in the energy expenditure and processing costs. Further, smaller capacity pumps can be used and heat exchangers and buffer tanks can be eliminated. Another advantage is the ability to achieve a higher percentage solids target at a higher temperature relative to that achieved at the lower temperatures of the prior art. Towards that end, the assembly end plates, the filter sheets, the retentate sheets, and permeate sheets (and the optional permeate screen spacer sheets) are made of materials which are adapted to accommodate high temperatures, so that the interior surfaces of the filtration cassette are able to withstand higher processing temperature and/or extreme pH and may be steam sterilized and/or chemically sanitized solutions for regeneration and reuse, as “steam-in-place” and/or “sterilizable in situ” structures, respectively. In one embodiment, liquid source materials having temperatures in a range from about 1° C. to about 130° C. can be introduced into the cross-flow filter cassettes. Other temperature ranges contemplated include about 1° C. to about 37° C., about 10° C. to about 30° C., greater than 10° C. to about 25° C., and greater than 10° C. to about 20° C. Alternatively, the entire cassette may be formed of materials which render the cassette disposable in character.

In some embodiments, a cross-flow filtration cassette for use in the methods and systems described herein comprises at least one assembly, wherein the at least one assembly comprises:
a multilaminate array of sheet members of generally rectangular and generally planar shape, each sheet of the array having a first end, a second end longitudinally opposite the first end, and a thickness, wherein the sheet members comprise in sequence in said array, a first retentate sheet, (a permeate pack and a second retentate sheet)ₙ, wherein n=1, 2, 3, 4, 5, 6, 7, 8, 9, 10, or more, wherein the permeate pack comprises a first filter sheet, a permeate sheet, and a second filter sheet, wherein each sheet in each permeate pack has at least one fluid opening at the first end thereof and at least one fluid opening at the second end thereof, wherein corresponding fluid openings at the first end of each sheet in each permeate pack are in register with one another and corresponding fluid openings at the second end of each sheet in each permeate pack are in register with one another, wherein the first and second retentate sheets have at least one channel opening therein, each channel opening extending longitudinally between a first channel entrance positioned proximate to fluid openings at the first end of the permeate pack and a second channel entrance positioned proximate to fluid openings at the second end of the permeate pack in the array, and wherein the at least one channel opening is open through the entire thickness of the first and second retentate sheets to permit a fluid to contact adjacent filter sheets, and wherein the first and second retentate sheets are bonded to adjacent filter sheets about peripheral end and side portions thereof; and
two assembly end plates sandwiching the multilaminate array of sheets, each end plate having a first end and a second end corresponding to that of the multilaminate array of sheets, wherein the two assembly end plates comprise at least one fluid opening at the first end thereof and at least one fluid opening at the second end thereof, wherein fluid openings of the end plates are in register with corresponding fluid openings of the permeate pack,
wherein the at least one assembly further comprises at least one permeate passage opening at longitudinal side margin portions of the sheet members of the assembly,
   wherein the filtration cassette further comprises a cap positioned on at least a portion of at least one fluid opening of the permeate pack, wherein the cap is positioned proximate to channel entrances of the first and second retentate sheets, and wherein the cap has a general U-shape and transverses the permeate pack through the fluid opening and at least partially overlaps a first side of the first filter sheet and at least partially overlaps a second side of the second filter sheet, with the permeate sheet positioned therebetween.

In some embodiments, a filtration cassette for use in the methods and systems described herein comprises at least one assembly, wherein the at least one assembly comprises:
a multilaminate array of sheet members of generally rectangular and generally planar shape, each sheet of the array having a first end, a second end longitudinally opposite the first end, and a thickness, wherein the sheet members comprise in sequence in said array, a first retentate sheet, (a permeate pack and a second retentate sheet), wherein n=1, 2, 3, 4, 5, 6, 7, 8, 9, 10, or more, wherein the permeate pack comprises a first filter sheet, a permeate sheet, and a second filter sheet, wherein each sheet in each permeate pack has at least one fluid opening at the first end thereof and at least one fluid opening at the second end thereof, wherein corresponding fluid openings at the first end of each sheet in each permeate pack are in register with one another and corresponding fluid openings at the second end of each sheet in each permeate pack are in register with one another, wherein the first and second retentate sheets have at least one channel opening therein, each channel opening extending longitudinally between a first channel entrance positioned proximate to fluid openings at the first end of the permeate pack and a second channel entrance positioned proximate to fluid openings at the second end of the permeate pack in the array, and wherein the at least one channel opening is open through the entire thickness of the first and second retentate sheets to permit a fluid to contact adjacent filter sheets, and wherein the first and second retentate sheets are bonded to adjacent filter sheets about peripheral end and side portions thereof; and
two assembly end plates sandwiching the multilaminate array of sheets, each end plate having a first end and a second end corresponding to that of the multilaminate array of sheets, wherein the two assembly end plates comprise at least one fluid opening at the first end thereof and at least one fluid opening at the second end thereof, wherein fluid openings of the end plates are in register with corresponding fluid openings of the permeate pack,
wherein the at least one assembly further comprises at least one permeate passage opening at longitudinal side margin portions of the sheet members of the assembly,
   wherein the permeate sheet comprises a metal matrix or other reinforced porous material of requisite thickness, wherein a width of the permeate passage opening of the permeate sheet is less than a width of the permeate passage opening of each of the filter sheets and retentate sheets in the multilaminate array of sheets.

The system and method described herein can comprise the cross-flow filtration cassette devices described herein, which enables control of the separation size and washing of the solids. The use of the cross-flow filtration cassette devices can be optimized to maximize passage of the aroma and flavor species of the juice into the respective permeate. Advantageously, the cross-flow filtration cassette devices described herein can be constructed to withstand high clean-in-place temperatures and comprise open channels which enables ready cleanability (e.g., of pectin) at typical intervals. Moreover, the cross-flow filtration cassette devices described herein prevent occlusion of the membrane and have less torturous pathways for passage of the solid phase of the raw feed juice.

Computer Programs

The present subject matter is described as a system, and a method of using same, but also can be a computer program product. In some embodiments, the computer program product may include a computer readable storage medium (or media) having computer readable program instructions thereon for causing a processor to carry out the systems or methods described herein.

In some embodiments, the computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations of the systems and methods described herein may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform systems and methods described herein.

In some embodiments, the computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In some embodiments, the computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In some embodiments, the computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Accordingly, in a third aspect, a non-transitory computer-readable storage medium is described, which stores a computer program thereon which, when run in a computer, causes the computer to carry out the systems and methods described herein.

The features and advantages of the invention are more fully illustrated by the following non-limiting examples, wherein all parts and percentages are by weight, unless otherwise expressly stated.

### EXAMPLES

A final juice obtained using a system and method described herein was stored at room temperature for several months. At two months' time there was not a negative impact to flavor quality (not tested by professional taste testers). At one months' time there was no visible indication of a quality change. At two months' time there was a browning of a 100 kDa cut of this juice stored at room temperature, but not a 10 kDa cut of the juice. Without being bound by theory, it is believed that the browning was caused by pectinestererase, which was removed by the 10 kDa cut but not the 100 kDa cut. As a result, the product obtained using a system and method described herein provides extended shelf life to the juice, even when refrigeration is not reliable.

Orange juice produced using a system and method described herein was stored side-by-side with a fresh squeezed commercial brand beyond the 10-day shelf life. No bacterial growth was observed at 60 days in the juice produced using a system and method described herein, but the commercial bottle ruptured its seal (popped). It is suspected that bacterial growth and outgassing led to rupture.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

1. A system for processing a raw juice feed to a final juice selected from the group consisting of a final juice comprising solids and a substantially solid-free final juice, said system comprising:
(a) a large pulp separation device to separate the raw juice feed into a first fraction comprising large pulp and a second fraction, wherein wash water is introduced during separation to strip some or all of the first fraction of sugars and other desirable species, and wherein the second fraction comprises at least one of juice, fine pulp, wash water, sugars, and other desirables;
(b) at least one liquid-solid separation device to separate the second fraction into a permeate comprising the juice, wash water, sugars and other desirables and a retentate comprising the fine pulp, suspended solids, and non-suspended solids;
(c) optionally, a hot pasteurization device, wherein at least a portion of the retentate, the first fraction, or both, are introduced and subjected to a temperature and a time necessary to kill microorganisms and to denature any undesirable enzymes to produce a sterile solid;
(d) a reverse osmosis (RO) device, wherein the permeate is introduced to standardize Brix and yield a RO permeate fraction comprising process water and a RO retentate fraction comprising standardized, substantially solid-free juice;
(e) at least one microorganism reduction device to sterilize the RO retentate fraction to produce a liquid that is sterile or otherwise has a substantially reduced bioburden, wherein the sterile liquid is the substantially solid-free final juice; and
(f) optionally, a recombiner for combining the sterile solid and the sterile liquid of (e) to produce a final juice comprising solids,
wherein only the RO retentate fraction is introduced to the at least one microorganism reduction device to sterilize or reduce the bioburden of same to produce the sterilized RO retentate fraction for the final juice.

2. The system of claim 1, wherein the RO permeate fraction is used as the wash water.

3. The system of claim 1, wherein the RO permeate fraction is introduced to the at least one liquid-solid separation device for diafiltration.

4. The system of claim 1, wherein the at least one liquid-solid separation device comprises at least one of dead-end filtration, centrifugation, tangential cross-flow filtration, and reverse osmosis.

5. The system of claim 4, wherein the at least one liquid solid separation device comprises a single cross-flow filtration device, a first cross-flow filtration device and a second cross-flow filtration device arranged in series, or at least three cross-flow filtration devices arranged in series.

6. The system of claim 1, wherein the at least one microorganism reduction device comprises a sterile filter, a bioburden reduction filter, or both a bioburden reduction filter and a sterile filter.

7. The system of claim 1, wherein the at least one microorganism reduction device never achieves a temperature greater than 30° C.

8. The system of claim 1, wherein the first fraction is not moved directly to an ultrafiltration device.

9. A method of processing a raw juice feed to produce a final juice selected from the group consisting of a final juice comprising solids and a substantially solid-free final juice, said method comprising:
(a) separating the raw juice feed into a first fraction comprising large pulp and a second fraction, wherein wash water is introduced during the separation to strip some or all of the first fraction of sugars and other desirable species, and wherein the second fraction comprises at least one of juice, fine pulp, wash water, sugars, and other desirables;
(b) separating the second fraction into a permeate comprising the juice, wash water, sugars and other desirables and a retentate comprising the fine pulp, suspended solids, and non-suspended solids;
(c) optionally heating at least a portion of the retentate, the first fraction, or both, at a temperature and a time necessary to kill microorganisms and to denature any undesirable enzymes to produce a sterile solid;
(d) introducing the permeate to a reverse osmosis device to standardize Brix and yield a RO permeate fraction comprising process water and a RO retentate fraction comprising standardized, substantially solid-free juice;
(e) reducing the microorganism count of the RO retentate fraction to produce a liquid that is sterile or otherwise has a substantially reduced bioburden, wherein the sterile liquid is the substantially solid-free final juice; and
(f) optionally, recombining the sterile solid and the sterile liquid of (e) to produce a final juice comprising solids,
wherein only the RO retentate fraction is introduced to the at least one microorganism reduction device to sterilize or reduce the bioburden of same to produce the sterilized RO retentate fraction for the final juice.

10. The method of claim 9, wherein the raw juice feed comprises oranges, grapefruit, limes, tangerines, lemons, tangelos, apricot, cranberry, blueberry, grape, peach, pear, papaya, banana, pineapple, apple, kiwi, raspberry, strawberry, aloe, guava, mango, tomato, watermelon, vegetables, Pineapple oranges, Hamlin oranges, Parson Brown oranges, Valencia oranges, tangerines, mandarin oranges, blood oranges, naval oranges, and any combination thereof.

11. The method of claim 9, wherein the RO permeate fraction is used as the wash water.

12. The method of claim 9, wherein the second fraction is separated into a permeate and a retentate using at least one liquid-solid separation device.

13. The method of claim 12, wherein the RO permeate fraction is introduced to the at least one liquid-solid separation device for diafiltration.

14. The method of claim 12, wherein the at least one liquid-solid separation device comprises at least one of dead-end filtration, centrifugation, tangential cross-flow filtration, and reverse osmosis.

15. The method of claim 14, wherein the at least one liquid solid separation device comprises a single cross-flow filtration device, a first cross-flow filtration device and a second cross-flow filtration device arranged in series, or at least three cross-flow filtration devices arranged in series.

16. The method of claim 9, wherein the microorganism count of the RO retentate fraction is reduced using at least one microorganism reduction device selected from a sterile filter, a bioburden reduction filter, or both a bioburden reduction filter and a sterile filter.

17. The method of claim 16, wherein the at least one microorganism reduction device never achieves a temperature greater than 30° C.

18. The method of claim 9, wherein the first fraction is never moved directly to an ultrafiltration device.

19. The method of claim 9, wherein, other than process startup, the only source of water in the process is that found in the original raw juice feed.

20. The method of claim 9, wherein:
the final juice is substantially devoid of linalool acetate;
the final juice has a shelf-life of at least about 60 days, without refrigeration, while being substantially devoid of preservatives;
the final juice is substantially devoid of flavor and aroma packs; and
the heat sensitive nutrients of the raw juice feed were not destroyed during processing and as such do not need to be supplemented to the final juice.
